(19) United States
(12) Patent Application Publication
(10) Pub. No.: US 2025/0076791 A1
(43) Pub. Date: Mar. 6, 2025

(54) IMAGE FORMING APPARATUS

(71) Applicant: Konica Minolta, Inc., Tokyo (JP)

(72) Inventors: Yuya SATO, Tokyo (JP); Daisuke KODAMA, Tokyo (JP)

(21) Appl. No.: 18/814,982

(22) Filed: Aug. 26, 2024

(30) Foreign Application Priority Data
Aug. 31, 2023 (JP) 2023-141637

(51) Int. Cl. G03G 15/16

(52) U.S. Cl. CPC G03G 15/1685; G03G 15/1675; G03G 15/168

(57) ABSTRACT

An image forming apparatus suppresses occurrence of pinholes. The image forming apparatus includes an image bearing member that carries a toner image, a secondary transfer body that sandwiches a recording material together with the image bearing member, and a potential difference forming section that forms a potential difference between a potential of the image bearing member and a potential of the secondary transfer body. The image bearing member and the secondary transfer body have a belt shape and contain a resin having electronic conductivity, and the secondary transfer body has a volume resistivity of 1×10^{9.7} Ω·cm or more.

### CROSS-REFERENCE TO RELATED APPLICATION

The entire disclosure of Japanese patent Application No. 2023-141637, filed on Aug. 31, 2023, is incorporated herein by reference in its entirety.

### BACKGROUND OF THE INVENTION

### 1. Technical Field

The present invention relates to an image forming apparatus.

### 2. Description of Related Art

In recent years, an image forming apparatus has been required to form an image on a thinner recording material. A thin recording material is likely to stick to a transfer section. Therefore, a conveyance failure is likely to occur due to the thin recording material. In order to cope with the conveyance failure, an intermediate transfer belt system and a secondary transfer belt system are adopted in the image forming apparatus (see, for example, Japanese Unexamined Patent Application Publication No. 2017-072689). By sandwiching the recording material between an intermediate transfer belt and a secondary transfer belt, a toner image formed on the intermediate transfer belt is transferred onto the recording material. In the image forming apparatus having such a configuration, good separability is ensured even for a thin recording material.

The image forming apparatus including the intermediate transfer belt system and the secondary transfer belt system described in Japanese Unexamined Patent Application Publication No. 2017-072689 includes the intermediate transfer belt in which a resin layer, an elastic layer, and a coated layer are laminated.

Further, Japanese Unexamined Patent Application Publication No. 2017-072689 describes polyimide as a material forming the resin layer of the intermediate transfer belt. The image forming apparatus described in Japanese Unexamined Patent Application Publication No. 2017-072689 includes a low-hardness resin and an elastic body in a secondary transfer body.

### SUMMARY OF THE INVENTION

The image forming apparatus described in Japanese Unexamined Patent Application Publication No. 2017-072689 suppresses the occurrence of minute print omissions, so-called pinholes (white voids, white spots) in an image formed on a recording material by adjusting a transfer bias to the recording material. However, in the image forming apparatus, the adjustment or control of the transfer bias alone may be insufficient for suppression of occurrence of pinholes. Therefore, there is a demand for an image forming apparatus that can further suppress occurrence of pinholes.

In order to solve the above-described problem, an object of the present invention is to provide an image forming apparatus capable of suppressing occurrence of pinholes.

The image forming apparatus according to the present invention includes an image bearing member that carries a toner image, a secondary transfer body that sandwiches a recording material together with the image bearing member, and a potential difference forming section that forms a potential difference between a potential of the image bearing member and a potential of the secondary transfer body. The image bearing member and the secondary transfer body have a belt shape and contain a resin having electronic conductivity, and the secondary transfer body has a volume resistivity of 1×10^{9.7} Ω·cm or more.

### BRIEF DESCRIPTION OF THE DRAWINGS

The advantages and features provided by one or more embodiments of the invention will become more fully understand from the detailed description given hereinbelow and the appended drawings which are given by way of illustration only, and thus are not intended as a definition of the limits of the present invention.

FIG. 1 is a diagram illustrating a schematic configuration of an image forming apparatus;

FIG. 2 is a diagram illustrating a configuration around a secondary transfer section of the image forming apparatus;

FIG. 3 is a schematic diagram of a secondary transfer nip formed at a transfer position;

FIG. 4 is a diagram illustrating a configuration of a roller having a straight shape;

FIG. 5 is a diagram illustrating a configuration of a roller having a non-straight shape;

FIG. 6 is a diagram illustrating a configuration of a roller having a non-straight shape;

FIG. 7 is an enlarged view of the vicinity of a separation section;

FIG. 8 is an enlarged view of the vicinity of the separation section;

FIG. 9 is a diagram illustrating a configuration of a separation assisting section;

FIG. 10 is a diagram illustrating a shape (modification example) of an electrode of the separation assisting section;

FIG. 11 is an enlarged view of the transfer position in a secondary transfer process;

FIG. 12 is an enlarged view of the transfer position in the secondary transfer process;

FIG. 13 is an enlarged view of the transfer position in the secondary transfer process when a pinhole occurs;

FIG. 14 is an enlarged view of the transfer position in the secondary transfer process when a pinhole occurs;

FIG. 15 is a graph of a relationship between volume resistivity and pinholes;

FIG. 16 is a graph of a relationship between volume resistivity and a pinhole OK current value range; and

FIG. 17 is a graph of a relationship between a value of an inflow current to an opposing roller and a secondary transfer voltage.

### DETAILED DESCRIPTION

Hereinafter, embodiments for implementing the present invention will be described, but the present invention is not limited to the following examples.

### <1. Embodiment of Image Forming Apparatus>

The following explains a configuration of an image forming apparatus according to the present embodiment with reference to the drawings. In the following description, the same components are denoted by the same symbols, and redundant descriptions are omitted. In addition, dimensional ratios in the drawings are exaggerated for convenience of description and may be different from actual ratios. In addition, in the following description, a numerical range indicated by “to” includes upper and lower limit numerical values unless otherwise specified.

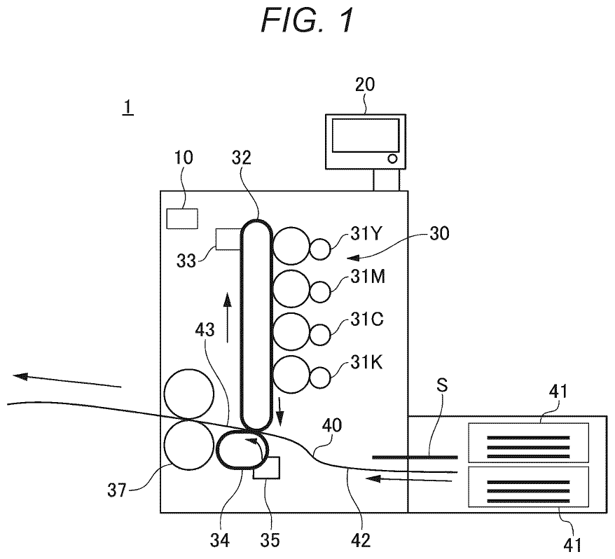

FIG. 1 illustrates a configuration of the image forming apparatus according to the present embodiment. The image forming apparatus 1 illustrated in FIG. 1 includes a controller 10, an operation display part 20, an image former 30, and a conveyance section 40.

The controller 10 includes a central processing unit (CPU), a read only memory (ROM), a random access memory (RAM), and the like (not illustrated). The CPU is an example of a calculating section for the image forming apparatus 1. The CPU centrally controls the operation of each section of the image forming apparatus 1. The CPU reads a program code of software regarding various processes of the image forming apparatus 1 stored in the ROM (an example of a recording medium), and develops the program code in the RAM. Then, the CPU controls the image forming apparatus 1 in accordance with the developed program. The controller 10 may include another calculating section such as a micro processing unit (MPU) as a calculating section instead of the CPU.

The operation display part 20 includes a display part and an operation part. The display part includes a display such as a liquid crystal display device. The operation part includes a touch screen, a plurality of keys, and the like, which are provided on the display. The operation display part 20 is an example of a display part and an operation part, and displays an instruction menu for a user, information regarding acquired image data, and the like.

### [Image Former]

The image former 30 includes image forming sections 31, an intermediate transfer belt 32, a secondary transfer section 34, and a fixing section 37.

The image forming sections 31 include components corresponding to respective basic colors of yellow (Y), magenta (M), cyan (C), and black (K). In FIG. 1, the image forming sections 31 of the respective basic colors are represented by an image forming section 31Y, an image forming section 31M, an image forming section 31C, and an image forming section 31K.

Each of the image forming sections 31Y, 31M, 31C, and 31K includes a photosensitive drum, a charging electrode, an exposure section, a developing device, a cleaning section, a primary transfer section, and the like. The configurations of the image forming sections 31Y, 31M, 31C, and 31K are the same except for the colors of toner of developer stored in the developing devices.

The developing devices of the image forming sections 31Y, 31M, 31C, and 31K contain two-component developer. Two-component developer includes small-diameter toners of yellow, magenta, cyan, and black, and carriers. In the carriers, ferrite is used as a core and an insulating resin is coated around the core. The toner is composed mainly of polyester, and a colorant, such as a pigment or carbon black, and external additives, such as a charge control agent, silica, and titanium oxide, are added to the toner.

The carriers have a particle diameter of 15 μm to 100 μm and a saturation magnetism of 10 emu/g to 80 emu/g. The toner has a particle diameter of 3 μm to 15 μm. The charging characteristics of the toner are negative charging characteristics. The toner has an average charge amount of −20 μC/g to −60 μC/g. Two-component developer is a mixture of these carriers and toner with a toner concentration of 4% to 10% by mass.

### (Intermediate Transfer Belt)

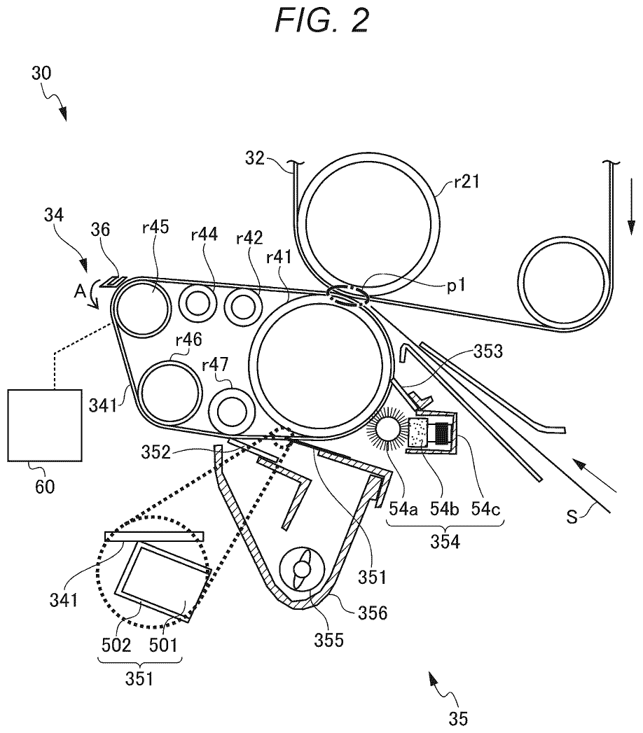

The intermediate transfer belt 32 is a toner bearing member (image bearing member). The intermediate transfer belt 32 is rotatably stretched around a plurality of rollers. The intermediate transfer belt 32 is driven in a clockwise rotation direction in the drawing. The plurality of rollers around which the intermediate transfer belt 32 is stretched include an opposing roller r21 (FIG. 2). The opposing roller r21 forms a transfer nip with the secondary transfer section 34. The opposing roller r21 includes, for example, nitrile butadiene rubber (NBR) as a material. The opposing roller r21 has a rubber hardness of 40° (Asker-C) and a volume resistivity of 1×10⁸ Ω·cm.

The intermediate transfer belt 32 contains a resin serving as a base and an electron conductive material. The resin serving as the base is, for example, acrylic, polyester, polycarbonate, polyimide, urethane, nylon, vinyl chloride, polyamide, polyphenylene sulfide (PPS), or polyether ether ketone (PEEK). The volume resistivity of the intermediate transfer belt 32 is adjusted based on the amount of the electron conductive material contained in the resin base. The volume resistivity of the intermediate transfer belt 32 is preferably 10⁸ Ω·cm to 10¹¹ Ω·cm.

The electron conductive material is, for example, carbon black, super abrasion furnace (SAF), intermediate SAF (ISAF), high abrasion furnace (HAF), fast extruding furnace (FEF), general purpose furnace (GPF), semi-reinforcing furnace (SRF), fine thermal (FT), or medium thermal (MT). In addition, the electron conductive material is, for example, a conductive carbon-based substance such as carbon for color (ink) subjected to oxidation treatment or the like, pyrolytic carbon, natural graphite, or artificial graphite. Furthermore, the electron conductive material is, for example, a conductive metal oxide such as titanium oxide, zinc oxide, antimony-doped tin oxide, or indium oxide-tin oxide composite oxide (ITO). The electron conductive material is, for example, a metal such as nickel, copper, silver, germanium, aluminum, or a copper alloy, or an oxide thereof. Furthermore, the electron conductive material is, for example, a conductive polymer such as polyaniline, polypyrrole, or polyacetylene.

The intermediate transfer belt 32 preferably has a thickness of 50 μm to 90 μm. In particular, the thickness of the intermediate transfer belt 32 is preferably 50 μm to less than 70 μm. In a case where the thickness of the intermediate transfer belt 32 is excessively large, the cost increases. In addition, in a case where the thickness of the intermediate transfer belt 32 is too small, the intermediate transfer belt 32 is likely to be broken, resulting in poor assemblability. In addition, in a case where the thickness of the intermediate transfer belt 32 is too small, pinholes are likely to occur.

The intermediate transfer belt 32 may contain a metal oxide surface-treated with a silane-based coupling agent. The intermediate transfer belt 32 may have a coated layer (surface layer) containing SiO₂. The intermediate transfer belt 32 can form a highly releasable and highly durable surface by containing the metal oxide and the coated layer.

Furthermore, it is preferable that the intermediate transfer belt 32 do not contain fluorine and fluorine compounds, in particular, organic fluorine materials and organic fluorine compounds in consideration of an effect on the environment.

Toner images formed by the image forming sections 31Y, 31M, 31C, and 31K are sequentially transferred onto the surface of the intermediate transfer belt 32, superimposed, and then transferred onto a recording material S conveyed to a transfer position p1 (FIG. 2) by the primary transfer sections.

The secondary transfer section 34 comes into contact with a back surface of the recording material S at the transfer position p1. The secondary transfer section 34 transfers the toner onto a front surface of the recording material S. The recording material S onto which a full-color toner image has been transferred is conveyed to the fixing section 37. The fixing section 37 applies heat and pressure to the recording material S and the toner image. Thus, the image former 30 forms the full-color image on the recording material S.

Toner that has not been transferred to the recording material S remains on the intermediate transfer belt 32. Hereinafter, the toner remaining on the intermediate transfer belt 32 is referred to as residual toner. The residual toner is collected by a cleaning device 33 disposed on the intermediate transfer belt 32. The cleaning device 33 includes a brush roller, a lubricant supplier, a cleaning blade, and a housing that houses these components. The residual toner on the intermediate transfer belt 32 is cleaned by the cleaning blade. The surface of the intermediate transfer belt 32 is coated with a lubricant by the lubricant supplier.

The conveyance section 40 includes a plurality of supply trays 41 and recording material conveyance paths 42 and 43. A plurality of recording materials S are stacked on each of the supply trays 41. The conveyance section 40 conveys the recording materials S one by one from the supply tray 41. The conveyance section 40 includes a plurality of conveyance roller pairs arranged along the recording material conveyance paths 42 and 43, and a drive motor (not illustrated) that drives the conveyance roller pairs. The conveyance section 40 conveys each recording material S supplied from the supply tray 41 to the transfer position of the secondary transfer section 34 or the fixing section 37.

In the case of forming images on both sides of the recording material S, the conveyance section 40 conveys the recording material S having an image formed on one surface to a recording material conveyance path (not illustrated) for double-sided printing. The recording material S conveyed to the recording material conveyance path for double-sided printing is reversed in a switchback path, and then joins the recording material conveyance path 42 for single-sided printing again. Then, the image forming apparatus 1 forms an image on the other surface of the recording material S by the image former 30.

### [Secondary Transfer Section]

Next, the configurations of the secondary transfer section 34 of the image forming apparatus 1 and the periphery of the secondary transfer section 34 will be described. FIG. 2 illustrates a configuration of the secondary transfer section 34 and its periphery.

The secondary transfer section 34 includes a secondary transfer body 341 and rollers r41, r42, r44, r45, r46, and r47. The secondary transfer body 341 is a transfer member formed in an endless belt shape. The secondary transfer body 341 is rotatably stretched around the plurality of rollers r41, r42, r44, r45, r46, and r47. The secondary transfer body 341 is driven counterclockwise in the drawing (in the direction of an arrow A).

### (Secondary Transfer Body)

The secondary transfer body 341 contains a resin serving as a base and an electron conductive material. The resin serving as the base is, for example, acryl, polyester, polycarbonate, polyimide, urethane, nylon, vinyl chloride, polyamide, polyphenylene sulfide (PPS), or polyether ether ketone (PEEK).

The electron conductive material is, for example, carbon black, SAF, ISAF, HAF, FEF, GPF, SRF, FT, or MT. In addition, the electron conductive material is, for example, a conductive carbon-based substance such as carbon for color (ink) subjected to oxidation treatment or the like, pyrolytic carbon, natural graphite, or artificial graphite. Furthermore, the electron conductive material is, for example, a conductive metal oxide such as titanium oxide, zinc oxide, antimony-doped tin oxide, or indium oxide-tin oxide composite oxide (ITO). The electron conductive material is, for example, a metal such as nickel, copper, silver, germanium, aluminum, or a copper alloy, or an oxide thereof. Furthermore, the electron conductive material is, for example, a conductive polymer such as polyaniline, polypyrrole, or polyacetylene.

The secondary transfer body 341 preferably has a thickness of about 0.07 mm to 0.1 mm. Further, the secondary transfer body 341 may be sufficiently hard. For example, the Young modulus value of the secondary transfer body 341 measured by a tensile test method (JIS K 6301) is preferably about 700 MPa or more and 10 GPa or less.

The secondary transfer body 341 may have a coated layer (surface layer) containing silicon dioxide (SiO₂) on a surface of the secondary transfer body 341. The coated layer of the secondary transfer body 341 reduces a mechanical adhesion force C described later. The secondary transfer body 341 can have a pure water contact angle of 90° to 95° in a case where the secondary transfer body 341 has the coated layer of SiO₂. In a case where the secondary transfer body 341 is a polyimide base having electronic conductivity, the pure water contact angle is 75° to 80°. For this reason, the secondary transfer body 341 can increase the pure water contact angle and improve the releasability of the recording material S by the SiO₂ coated layer.

Increasing the surface roughness of the secondary transfer body 341 reduces the mechanical adhesion force C described later. By making the surface of the secondary transfer body 341 rough and reducing the contact area with the recording material S, the mechanical adhesion force C (FIG. 8) described later decreases. For example, the surface roughness is increased by spraying particles onto the secondary transfer body 341 by sandblasting or wet blasting, or supplying abrasive particles by bringing a blade into contact with the surface of the rotating secondary transfer body 341.

### (Secondary Transfer Roller)

The roller r41 is a secondary transfer roller (secondary transfer member). The roller r41 presses the secondary transfer body 341 toward the opposing roller r21. The roller r41 presses the secondary transfer body 341 with, for example, a force of 70 N. The opposing roller r21 is disposed on an inner peripheral surface side of the intermediate transfer belt 32.

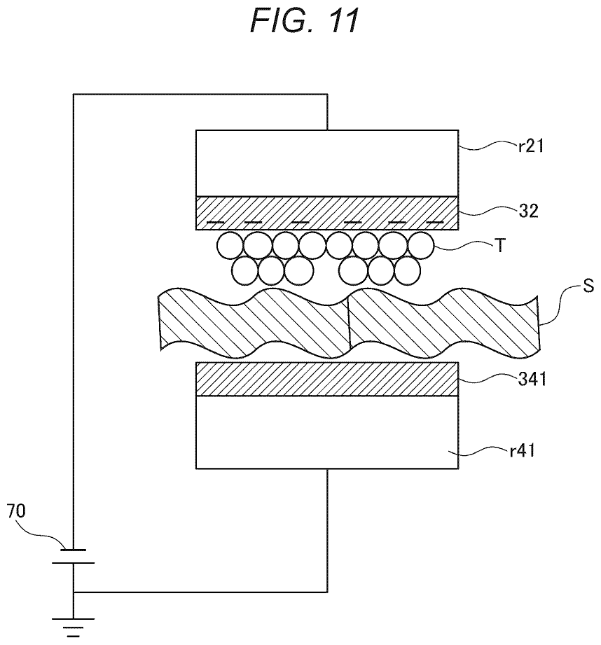

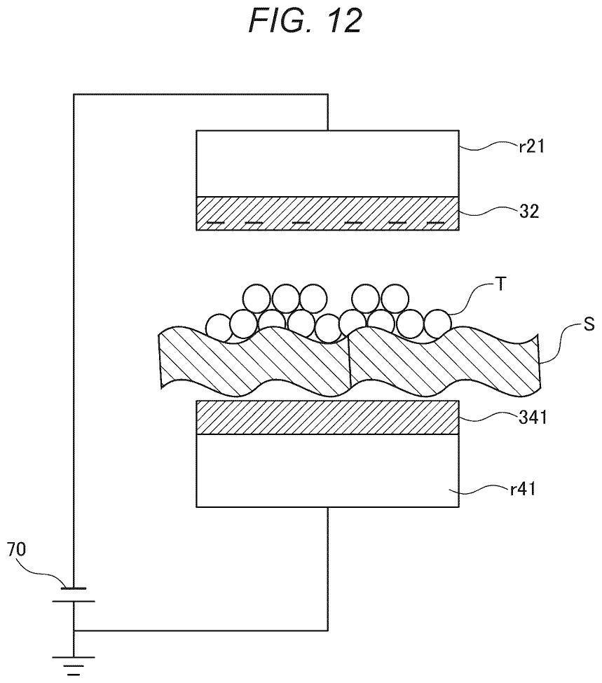

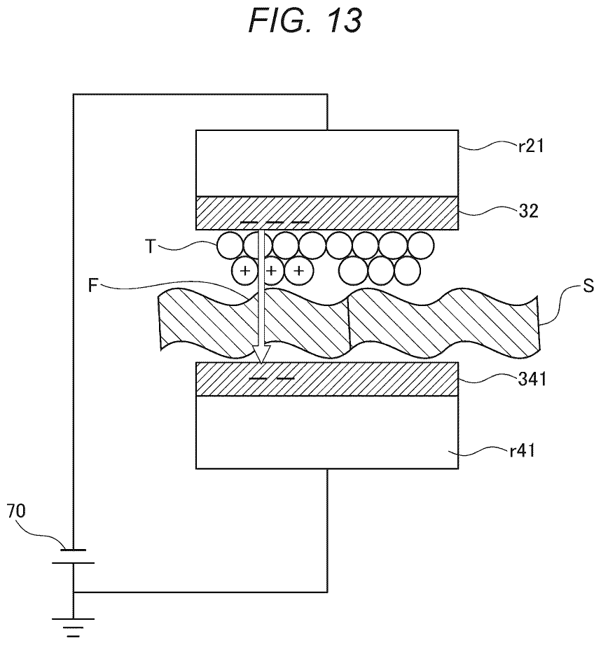

The roller r41 and the opposing roller r21 sandwich the intermediate transfer belt 32 and the secondary transfer body 341. The pressing of the roller r41 and the opposing roller r21 forms a secondary transfer nip between the intermediate transfer belt 32 and the secondary transfer body 341 at the transfer position p1. To transfer the toner image onto the recording material S, a predetermined voltage is applied to the roller r41 from an external potential difference forming section (FIG. 11). Alternatively, during the transfer of the toner image onto the recording material S, an electric current is supplied to the roller r41 from the potential difference forming section. The potential difference forming section includes a high-voltage power source and the like.

The roller r41 includes, for example, a conductive core metal (not illustrated) and a resin layer formed around the conductive core metal. The conductive core metal is, for example, stainless steel (SUS) or the like. The resin layer includes a rubber or a resin material such as polyurethane, EPDM, silicone, or nitrile butadiene rubber (NBR), and a filler dispersed in the rubber or the resin material. The resin layer may have a semiconductive coating material (about 0.05 mm to 0.5 mm) thereon. Furthermore, the coating material may be a semiconductive material in which an ionic conductive material is contained in a rubber or resin material.

The resin layer has a thickness of about 0.05 mm to 0.5 mm.

Note that it is more preferable that the roller r41 be formed of only a conductive core metal such as stainless steel without including the above-described resin layer and coating material.

The roller r41 and the opposing roller r21 have substantially the same outer diameter. The roller r41 and the opposing roller r21 have, for example, an outer diameter of 30 mm.

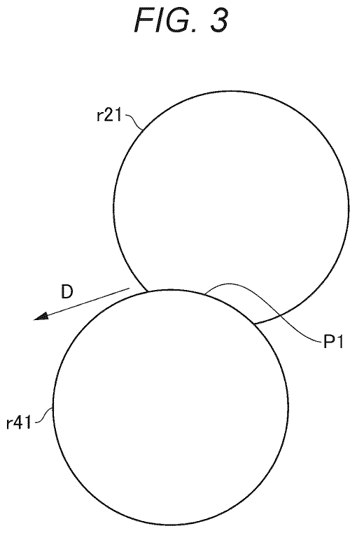

FIG. 3 schematically illustrates the secondary transfer nip formed at the transfer position p1. In FIG. 3, the configurations of the intermediate transfer belt 32, the secondary transfer body 341, and the like are omitted, and only the shapes of the opposing roller r21 and the roller r41 are schematically illustrated.

The roller r41 (secondary transfer roller) is preferably made of a high-hardness material such as stainless steel as described above. That is, the roller r41 is made of a material having a hardness higher than that of the opposing roller r21. In a case where the roller r41 has a higher hardness than the opposing roller r21, as illustrated in FIG. 3, the roller r41 protrudes toward the opposing roller r21 at the transfer position p1. Therefore, as illustrated in FIG. 3, the secondary transfer nip has a convex shape on the opposing roller r21 side. Thus, the recording material S ejected from the secondary transfer nip easily moves in the direction of an arrow D. The direction of the arrow D is a direction further away from the intermediate transfer belt 32 than the exit of the secondary transfer nip. Therefore, the recording material S is easily separated from the intermediate transfer belt 32. Then, the recording material S easily follows the secondary transfer body 341.

As a result, it is possible to prevent the recording material S from being jammed due to the winding of the recording material S around the intermediate transfer belt 32 during the conveyance of the recording material S. Note that the roller r41 may have a higher hardness than the that of the opposing roller r21. Theoretically, the roller r41 preferably has an Asker C hardness of 40° or more. The roller r41 more preferably has an Asker C hardness of 70° or more. Furthermore, it is preferable that the roller r41 not be rubber or foam but be a rigid body, and for example, it is preferable to use a metal having a Vickers hardness of 50 HV or more.

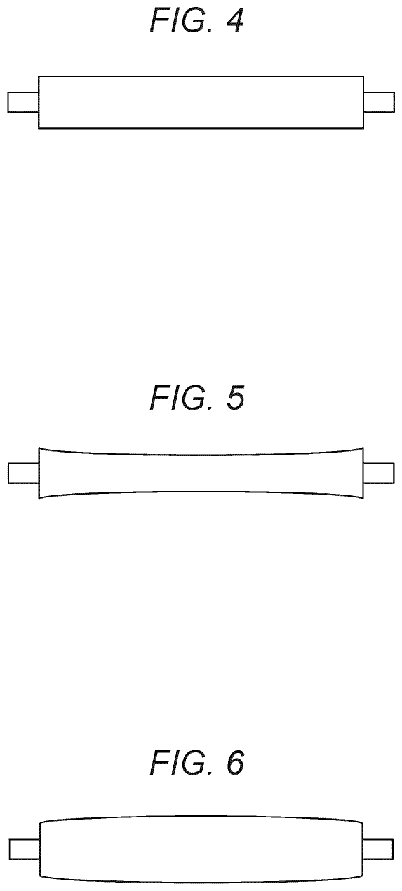

Further, the roller r41 (secondary transfer roller) has a straight shape. In the straight shape, as illustrated in FIG. 4, an outer diameter in a region of the roller r41 which comes into contact with the recording material S has the same in one end portion, a central portion, and the other end portion of the roller r41. It is preferable that the roller r41 have an outer diameter of 30 mm±0.15 mm over the entire region that comes into contact with the recording material S. More preferably, the roller r41 has an outer diameter equal to or smaller than 30 mm±0.1 mm over the entire region that comes into contact with the recording material S.

Note that the roller r41 (secondary transfer roller) may have a non-straight shape. FIGS. 5 and 6 illustrate examples of the configuration of the roller having a non-straight shape. As illustrated in FIGS. 5 and 6, the roller r41 (secondary transfer roller) may have intentionally different outer diameters in the end portions and the central portion. For example, in the roller r41, a difference in outer diameter between the central portion and the end portions may be 0.2 mm to 3 mm.

### (Drive Roller and Steering Roller)

The roller r45 functions as a drive roller. The roller r45 is driven by a driving section 60. The driving section 60 includes a stepping motor and a gear.

The roller r46 functions as a steering roller. The roller r46 is connected to a steering mechanism (not illustrated). The steering mechanism includes a drive source, an actuator, and a detection sensor. The steering mechanism shifts (inclines) the position of at least one of the end portions of the roller r46. The steering mechanism shifts (inclines) the position of the end portion in accordance with the position of an end portion of the secondary transfer body 341 detected by the detection sensor (not illustrated). The steering mechanism inclines a rotation axis of the roller r46 with respect to rotation axes of the rollers r41 and r45 and the like. Thus, the steering mechanism and the roller r46 control the movement of the secondary transfer body 341 to prevent meandering.

### [Cleaning Device]

On the secondary transfer body 341, foreign substances such as broken pieces of the recording material S and toner may remain. The foreign substances are collected by a cleaning device 35 (cleaning section) disposed on the secondary transfer body 341. The cleaning device 35 cleans the surface of the secondary transfer body 341. The secondary transfer section 34 and the cleaning device 35 are replaceable as a unit with a secondary transfer unit.

The cleaning device 35 includes a first blade 351, a second blade 352, a third blade 353 for pressing, a lubricant applying section 354, a conveyance screw 355, and a housing case 356. For example, the first blade 351 (hereinafter, also simply referred to as the blade 351, and the same applies to the blades 352 and 353) is mainly formed of a rigid member. The second blade 352 is mainly formed of an elastic member. Each of the blades 351, 352, and 353 is a thin-plate member and has a length of about ten and several millimeters in the lateral direction of the blade. The blades 351, 352, and 353 are slightly longer than the full width of the recording material in the longitudinal direction and are, for example, 300 mm to 400 mm.

As illustrated in FIG. 2, the blades 351, 352, and 353 are arranged so as to be in contact with the surface of the secondary transfer body 341 in the order of the blade 352, the blade 351, the lubricant applying section 354, and the blade 353 from the upstream side in the rotation direction of the secondary transfer body 341 with reference to the transfer position p1.

### (Second Blade)

The second blade 352 is formed of an elastic member, such as a rubber material. As the rubber material, urethane rubber is preferably used. Furthermore, the blade 352 may be formed of fluororubber, styrene-butadiene rubber, or nitrile rubber. The blade 352 has a thickness of, for example, 2 mm and is held by a holder so as to be in contact with the secondary transfer body 341 at a contact angle of 15° and a contact pressure of 30 N/m. The blade 352 is, for example, of a fixed type, and the holder is fixed to the housing case 356. The blade 352 has a free length of 9 mm from the holder. The roller r47 is disposed at a position opposing the contact position of the blade 352. The roller r47 functions as an opposing roller inside the secondary transfer body 341. The roller r47 is made of, for example, stainless steel or the like and has an outer diameter of 12 mm.

### (First Blade)

The first blade 351 is generally made of a harder material than the second blade 352. As illustrated in the enlarged view surrounded by a circle in FIG. 2, the blade 351 includes a base material 501 and a coated layer 502. The coated layer 502 covers the base material 501. The coated layer 502 covers at least the base material 501 in a region in contact with the secondary transfer body 341. For example, the coated layer 502 covers the base material 501 in a region of several millimeters from the leading end (e.g., a range of 2 mm from the leading end) that comes into contact with the toner bearing member. The base material 501 is preferably a metal-made rigid body, and more preferably a stainless steel (in particular, SUS304)-made rigid body. The blade 351 has a thickness of, for example, 0.1 mm, and is held by a holder fixed to the housing case 356 so as to be in contact with the secondary transfer body 341 at a contact angle of 10° and a contact pressure of 5 N/m. The blade 351 has a designed biting amount of 0.3 mm (e.g., a fixed type). The blade 351 has a free length of 10 mm from the holder.

The coated layer 502 is made of a material harder than the base material 501. The coated layer 502 is, for example, a boron-carbon-nitrogen (B—C—N)-based hard film. The coated layer 502 is preferably a diamond-like carbon (DLC) film. The thickness of the coated layer 502 can be set within a range of, for example, 0.01 μm to 10 μm. Providing such a hard coated layer 502 on the leading edge of the base material 501 of the blade 351 can reduce abrasion of the leading end and ensure durably stable cleaning performance.

Further, at a position where the blade 351 is in contact with the secondary transfer body 341, there is no opposing roller via the secondary transfer body 341. For this reason, even in a case where the contact pressure of the blade 351 is suddenly excessively increased, the secondary transfer body 341 can retract (is pushed down) toward the inside. Thus, breakage or damage of the secondary transfer body 341 due to the blade 351 having high hardness can be suppressed. Further, the secondary transfer body 341 at a position where the roller is inscribed is raised outward. When the blade 351 is arranged at a position facing the roller via the secondary transfer body 341, a gap is likely to occur between the secondary transfer body 341 and the blade 351. This is because the blade 351 cannot reduce the raised part of the secondary transfer body 341 due to its high hardness and low flexibility. Therefore, in a case where a roller is present opposite, via the secondary transfer body 341, a position with which the blade 351 is in contact with the secondary transfer body 341, a foreign substance adhering to the secondary transfer body 341 is likely to pass through a gap between the secondary transfer body 341 and the blade 351. Therefore, the cleaning ability of the blade 351 is reduced.

### [Third Blade]

The third blade 353 is a fixing blade that levels the lubricant supplied onto the secondary transfer body 341 from the lubricant applying section 354, which will be described later, and presses the lubricant against the surface of the secondary transfer body 341. As illustrated in FIG. 2, the first blade 351 and the second blade 352 are in contact with the secondary transfer body 341 in a counter method. The counter method is a contact method in which the leading end of each of the blades faces the upstream side in the movement direction of the secondary transfer body 341. On the other hand, the third blade 353 is held by a holder so as to be in contact with the secondary transfer body 341 by a trail method. The trail method is a method in which the leading end of the third blade 353 is directed to the downstream side in the movement direction of the secondary transfer body 341. The third blade 353 has a thickness of, for example, 1.6 mm and is in contact with the secondary transfer body 341 at a contact angle of 51°. The third blade 353 has a designed biting amount of 0.3 mm. The third blade 353 has a free length of 6 mm from the holder.

### [Lubricant Applying Section]

The lubricant applying section 354 includes a brush roller 54a, a solid lubricant 54b, and a support section 54c. The support section 54c has one end fixed to the housing. In the solid lubricant 54b, powder of a molten lubricant is solidified into a substantially rectangular parallelepiped shape. The solid lubricant 54b has, for example, a height of 4.5 mm, a depth of 8 mm, and a width of 8 mm.

The lubricant used in the solid lubricant 54b is selected from materials that can be applied to the surface of the secondary transfer body 341 and can reduce the adhesion force between an adhering substance such as toner and the secondary transfer body 341 by reducing surface energy. Examples of the lubricant include fatty acid metal salts and fluorine-based resins, which may be used alone or as a mixture of two or more thereof. In particular, the lubricant is preferably a fatty acid metal salt. Fatty acid forming the fatty acid metal salt is preferably a linear hydrocarbon. For example, as the hydrocarbon, myristic acid, palmitic acid, stearic acid, oleic acid and the like are preferable, and stearic acid is particularly preferable. Examples of metal forming the fatty acid metal salt include lithium, magnesium, calcium, strontium, zinc, cadmium, aluminum, cerium, titanium, and iron. Among these, zinc stearate, magnesium stearate, aluminum stearate, and iron stearate are preferable. In particular, zinc stearate is most preferable.

The support section 54c includes a holder and an elastic body. The holder holds the solid lubricant 54b. The clastic body is formed of a coil spring or the like. The elastic body presses (brings into contact with) the solid lubricant 54b against the brush roller 54a with a predetermined pressing force via the holder.

The biting amount of the brush roller 54a into the secondary transfer body 341 is, for example, 0.5 mm. The pressing force of the brush roller 54a in this case is 1 N.

The brush roller 54a is formed by implanting or winding brush fibers around a core metal having an outer diameter 6 mm. The brush roller 54a has, for example, an overall outer diameter of 12 mm. The brush fibers are made of, for example, a polyester material having a pile diameter of 4d and a pile concentration of 150 KF/inch². The resistance of the brush fibers is on the order of 1012 02. The brush roller 54a is rotationally driven by a driving section (not illustrated) in a counter direction with respect to the movement direction of the secondary transfer body 341. The brush roller 54a is rotationally driven to scrape the lubricant (lubricant powder) from the solid lubricant 54b and apply the lubricant to the surface of the secondary transfer body 341.

The toner, external additive, and the like scraped from the secondary transfer body 341 by the blades 351 and 352 fall downward along the inner surface of the housing case 356 covering the blades 351 and 352. The conveyance screw 355 is disposed at a lower portion of the housing case 356. The dropped toner and the like are conveyed to the back side of a device main body by the conveyance screw 355, and are collected in a collection box arranged on the back side of the device main body.

### [Separation Section]

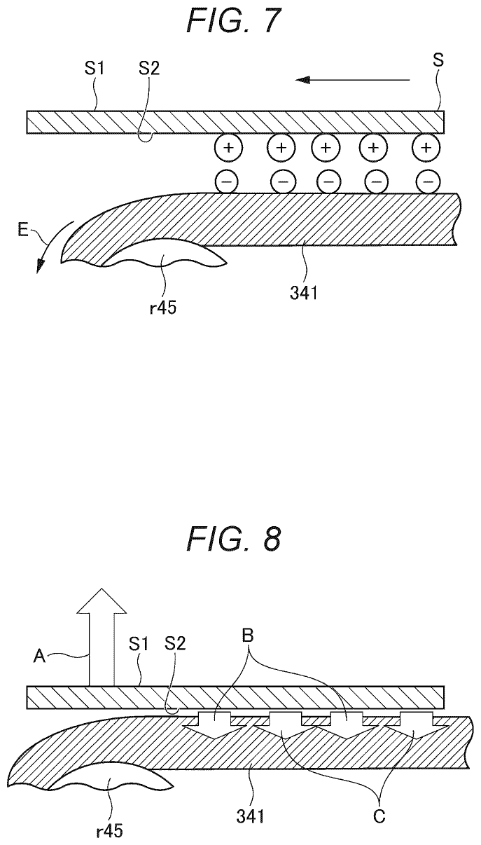

As illustrated in FIG. 2, the image forming apparatus 1 includes a separation section at a position of the roller r45n of the secondary transfer body 341. The separation section is a position where the recording material S is separated from the secondary transfer body 341. FIG. 7 is an enlarged view of the vicinity of the separation section.

As illustrated in FIG. 7, the second surface (back surface) S2 of the recording material S and the surface of the secondary transfer body 341 hold charges by a transfer current at the transfer position p1 (FIG. 2). For this reason, residual charges remain on the recording material S and the secondary transfer body 341 even during conveyance. In FIG. 7, a residual charge on the back surface S2 of the recording material S is indicated by “+”, and a residual charge on the secondary transfer body 341 is indicated by “−”. The back surface S2 of the recording material S and the surface of the secondary transfer body 341 are conveyed to the separation section in a state of being electrostatically attracted by the residual charges. FIG. 7 schematically illustrates the recording material S and the secondary transfer body 341 separately. The actual recording material S and the secondary transfer body 341 are in contact with each other by electrostatic attraction. Further, at the separation section, the first surface (front surface) S1 of the recording material S is not in contact with the transfer belt 32.

The recording material S conveyed to the separation section is separated from the secondary transfer body 341 by the radius of curvature formed by the roller r45. The recording material S separated from the secondary transfer body 341 allows a leading end of the recording material S to enter the fixing section 37 (FIG. 1). If the recording material S cannot be separated from the secondary transfer body 341, the recording material S is caught in the direction of an arrow E illustrated in FIG. 7. As a result, the recording material S is caught (separation failure) or clogging occurs.

FIG. 8 is a schematic diagram illustrating a force relationship at the separation section.

At the separation portion, a mechanical force A is generated on the recording material S. The mechanical force A is a force that causes the recording material S to resist, due to its rigidity, the bending of the secondary transfer body 341 that bends according to the radius of curvature of the roller r45.

On the other hand, an electrostatic attraction force B and the mechanical adhesion force C generated by the contact are generated between the recording material S and the secondary transfer body 341.

In this case, in a case where a force relationship of A>B+C is established, the recording material S is separated from the secondary transfer body 341.

In contrast, under the following conditions, the separation failure of the recording material S is likely to occur. When the force A is small and the forces B and C are large, the separation failure is likely to occur.
When the recording material S is thin, the recording material S has low rigidity. Therefore, the mechanical force A due to the rigidity of the recording material S is likely to be small.
When the recording material S is smooth, the recording material S and the secondary transfer body 341 are likely to come into close contact with each other. Therefore, the mechanical adhesion force C is likely to be large.
When a secondary transfer current is large, that is, when the potential difference formed between the opposing roller r21 and the roller r41 is large, the amount of residual charges is large and the electrostatic attraction force B is likely to be large.
When the processing speed is high, that is, when the movement speeds of the secondary transfer body 341 and the recording material S are high, the effect of the mechanical force A on the recording material S becomes relatively small.
In a case where the surface resistance of the secondary transfer body 341 is high, residual charges generated at the transfer position p1 are unlikely to disappear.
   Therefore, the electrostatic attraction force B is increased at the separation section.
The resistance of the secondary transfer body 341 that includes a high-hardness resin material as a base and has electronic conductivity is controlled by the amount of an electron conductive agent added. In addition, the secondary transfer body 341 is required to have a high volume resistivity in order to suppress the occurrence of a pinhole. Therefore, when the amount of a high-electron conductive agent added is reduced in order to increase the volume resistivity, the surface resistance of the secondary transfer body 341 increases. For this reason, the residual charges are less likely to disappear, the electrostatic attraction force B increases, and the separation failure of the thin recording material S is likely to occur.

### (Separation Assisting Section)

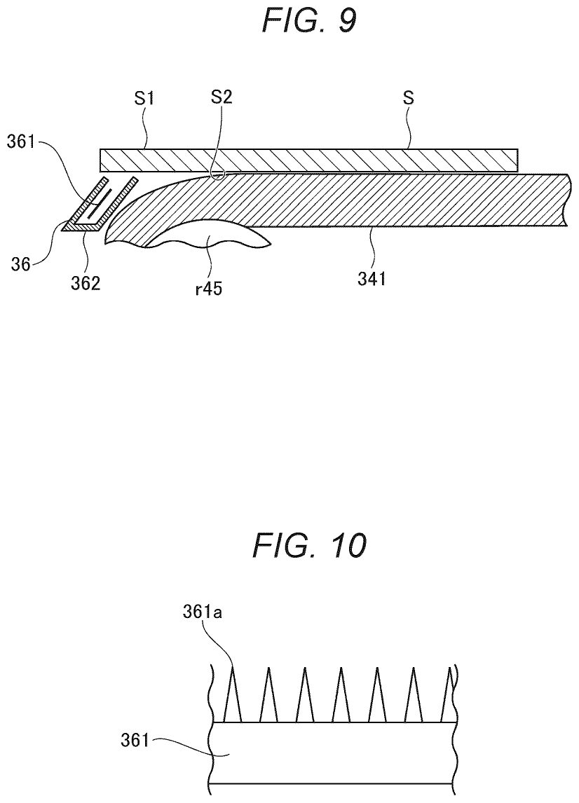

The image forming apparatus 1 includes a separation assisting section 36 in the vicinity of the separation section. FIGS. 9 and 10 illustrate a detailed configuration of the separation assisting section 36. As illustrated in FIG. 9, the separation assisting section 36 is arranged on the exit side of the transfer position p1 and adjacent to the most downstream side of an area where the secondary transfer body 341 takes charge of conveyance of the recording material S. That is, the separation assisting section 36 is arranged on the rear end side in the driving direction of the secondary transfer body 341 with reference to the transfer position p1. Further, the separation assisting section 36 is disposed at a position where the separation assisting section 36 does not contact the secondary transfer body 341 and the recording material S.

The separation assisting section 36 forms a potential difference between contacting surfaces of the recording material S and the secondary transfer body 341. The separation assisting section 36 cancels out residual charges on the second surface S2 of the recording material S with charges having the opposite polarity, to reduce the electrostatic attraction force B illustrated in FIG. 8 and assist the separation. The separation assisting section 36 includes a casing 362 and an electrode 361. A voltage having a polarity opposite to the charge polarity of the second surface S2 of the recording material S is applied to the electrode 361 from a power source (not illustrated).

The electrode 361 discharges charges in the direction of the second surface S2 of the recording material S, which is the opening direction of the casing 362. The electrode 361 discharges charges of the applied polarity by corona discharge.

The casing 362 is grounded. The casing 362 protects the electrode 361 so that discharge does not occur in a direction other than the second surface S2 of the recording material S from the electrode 361.

As the electrode 361, as illustrated in FIG. 9, a wire electrode stretched in the depth direction, that is, in the rotation axis direction of the secondary transfer body 341 can be used. The electrode 361 may be a needle-like electrode as illustrated in FIG. 10. In a case where the electrode 361 is a needle-like electrode, the electrode 361 is likely to discharge charges from a leading end 361a of the needle. For this reason, by directing the leading end 361a of the needle toward the second surface S2 of the recording material S, electric charges can be efficiently discharged to the recording material S.

Providing the separation assisting section 36 at the separation section reduces the electrostatic attraction force B between the recording material S and the secondary transfer body 341. The electrode 361 of the separation assisting section 36 includes a conductive member such as metal at least in a portion close to the recording material S. A distance between the electrodes 361 and the recording material S is about 1 mm to 5 mm. At the separation assisting section 36, electric discharge occurs on the recording material S due to a potential difference between the electrode 361 and the recording material S. Since the residual charges on the recording material S are removed, the electrostatic attraction force B can be reduced. Further, the separation assisting section 36 may be provided with a discharging voltage source (not illustrated) for applying a voltage of a polarity opposite to the charge polarity of the recording material S so that the discharge from the electrode 361 is likely to occur.

### [Principle of Occurrence of Pinholes]

Next, minute print omissions, so-called pinholes (white spots, white spots), which occur in an image formed on the recording material S, will be described. Note that the following description is an example of a pinhole occurrence mechanism estimated by the inventors, and the principle of pinholes that occur is not limited to this.

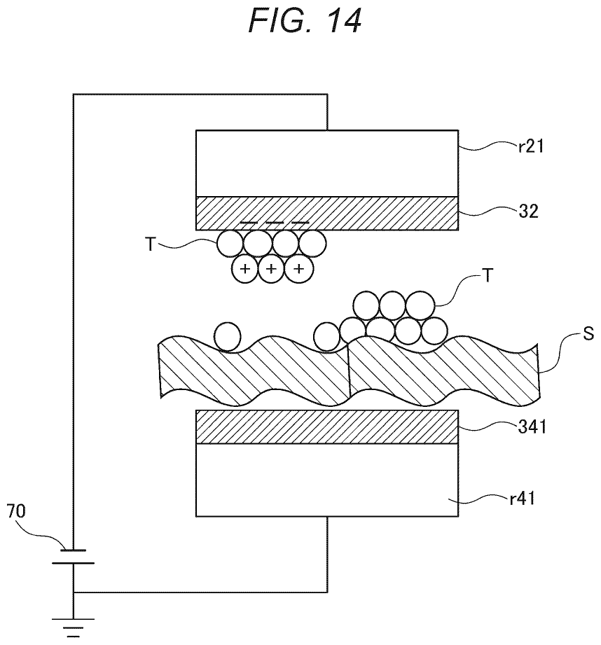

First, a normal transfer process will be described. FIGS. 11 and 12 are enlarged views of the transfer position p1. FIGS. 11 and 12 are schematic diagrams of a secondary transfer process. At the transfer position p1, the opposing roller r21 and the roller (secondary transfer roller) r41 sandwich the intermediate transfer belt 32, the recording material S, and the secondary transfer body 341. The intermediate transfer belt 32 carries toner T on its surface.

Furthermore, a predetermined voltage is applied to the roller r41 from an external potential difference forming section 70 (high-voltage power source). Accordingly, as illustrated in FIG. 11, a potential difference (secondary transfer bias) is formed at the transfer position p1 by the voltage applied from the potential difference forming section 70. Then, a secondary transfer electric field is generated during the nipping of the recording material S, and negatively charged toner T is transferred onto the surface of the recording material S by Coulomb force. As a result, as illustrated in FIG. 12, the toner T moves from the intermediate transfer belt 32 onto the recording material S, so that an image is formed on the surface of the recording material S.

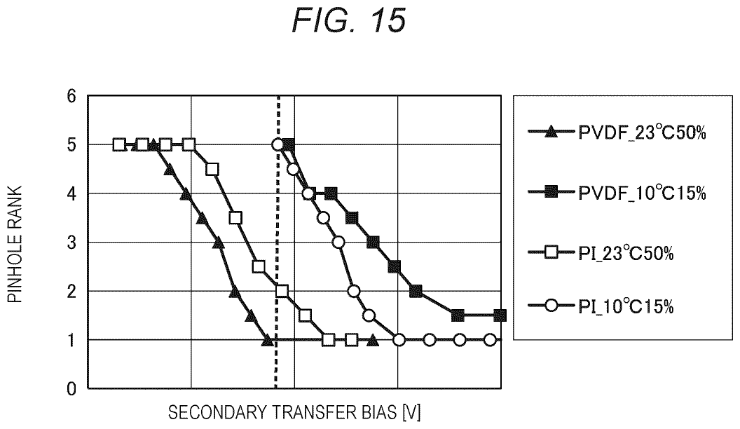

Next, the secondary transfer process at the time of the occurrence of a pinhole will be described. FIGS. 13 and 14 are enlarged views of the transfer position p1. Note that FIGS. 13 and 14 illustrate the same configuration as that illustrated in FIGS. 11 and 12 described above.

In the transfer of the toner T, a potential difference between the potential of the opposing roller r21 and the potential of the roller r41 is formed. In a case where a local low-resistance portion is present in the gap with respect to the potential difference, a conductive path is formed in the local low-resistance portion. In this case, discharge (discharge current) as indicated by an arrow F in FIG. 13 occurs in the conductive path.

Then, as illustrated in FIG. 14, the toner in the portion where the discharge has occurred remains on the surface of the intermediate transfer belt 32 without being transferred onto the surface of the recording material S. Thus, a white pinhole occurs in the image on the surface of the recording material S.

In a case where the potential difference (secondary transfer bias) is too large with respect to the local low-resistance portion in the gap, discharge is likely to occur. This discharge is likely to occur under the following conditions.
The secondary transfer bias is large.
A gap (discharge gap) is present between the surface (front surface) of the intermediate transfer belt 32 carrying a toner image and the surface (first surface; front surface) of the recording material S onto which the toner image is transferred.
The intermediate transfer belt 32 vibrates in the vicinity of the secondary transfer section. In a case where the intermediate transfer belt 32 is vibrating, a gap is likely to occur between the intermediate transfer belt 32 and the recording material S.
The recording material S has a small thickness and a large surface roughness. In this case, a gap is likely to occur between the intermediate transfer belt 32 and the recording material S.
The processing speed is high. That is, the movement speeds of the secondary transfer body 341 and the recording material S are high. In this case, the gap between the intermediate transfer belt 32 and the secondary transfer body 341 is narrowed at a high speed, and thus discharge is likely to occur.
The opposing roller r21, the intermediate transfer belt 32, and the secondary transfer body 341 include low-resistance portions. This is likely to occur due to uneven dispersion of a conductive agent (electron conductive material) of the intermediate transfer belt 32.
The resistances of the opposing roller r21, the intermediate transfer belt 32, and the secondary transfer body 341 fluctuate.

### [Processing Speed]

The controller 10 controls the conveyance speed of the recording material S in the conveyance section 40. The conveyance speed of the recording material S is controlled by controlling the driving speeds (rotation speeds) of the intermediate transfer belt 32 and the secondary transfer body 341.

In a case where the thickness of the recording material S is small, as the process speed is high, a pinhole is likely to occur. In addition, a sheet jam due to separation failure is likely to occur. The more high-end the image forming apparatus is, the more problematic it is to achieve both a reduction in a pinhole and the separation of the recording material S having a small thickness. An on-demand printing machine which is also required to cope with the thin recording material S is often a product that performs printing on 80 or more A4 horizontal pages per minute. That is, as obtained from the following calculation formula, the image forming apparatus 1 is required to have a processing speed of 310 mm/sec or more (about a distance of 20 mm between recording materials). Therefore, the controller 10 is required to control conveyance of the recording material S at a processing speed of 310 mm/sec or more.

(a width of 210 [mm] of an A4 sheet+an interval of 20 [mm] between sheets)×80 [sheets/minute]=230 [mm/sheet]×80 [sheets/minute]=18400 [mm/minute]=306.7 [mm/second]≈310 [mm/second]

An image forming apparatus AccurioPress C14000 manufactured by Konica Minolta, Inc. was prepared, and a secondary transfer body of the image forming apparatus AccurioPress C14000 was changed to secondary transfer bodies of Examples 1 to 6 and Comparative Example 1 described below.

### Examples 1 to 3, Example 6, and Comparative Example 2

Pellets obtained by mixing an electronically conductive material and a desired additive with a resin serving as a base were molded by being melted and extruded from a cylindrical mold or melted and applied to a cylindrical mold. The secondary transfer bodies were produced by adjusting shapes of the secondary transfer bodies by further annealing in an adjusted environment.

In this case, the secondary transfer bodies of Example 1, Example 2, Example 3, Example 6, and Comparative Example 2 having different volume resistivity were produced by changing the amount of an electron conductive material to be added. The volume resistivity of each secondary transfer body is listed in Table 1 below.

### Example 4

The secondary transfer body of Example 4 was produced in the same manner as in Example 2 except that the driving of the separation assisting section of the image forming apparatus was turned off.

### Example 5

The surface of the secondary transfer body produced in the same manner as in Example 2 was roughened by wet blasting, and the secondary transfer body of Example 5 was produced.

### Comparative Example 1

The secondary transfer body of Comparative Example 1 was produced in the same manner as in Example 1 except that a base was changed to polyvinylidene fluoride (PVDF).

### [Evaluation Method]

The following measurement and evaluation were performed on the secondary transfer bodies of Examples 1 to 6 and Comparative Examples 1 and 2 produced by the above-described methods.

### (Resistance Measurement)

Under an environment at a temperature of 23° C. and a humidity of 50%, the volume resistivity and surface resistivity of each secondary transfer body were measured. For the measurement, a Hiresta UX MCP-HT450 URS probe manufactured by Mitsubishi Chemical Analytech Co., Ltd. was used. The volume resistivity was measured under conditions after 10 seconds from the time when a voltage of 500 V was applied. The surface resistivity was measured under conditions after 10 seconds from the time when a voltage of 1 kV was applied.

### (Pinhole Evaluation)

AccurioPress C14000 manufactured by Konica Minolta, Inc. was modified so that an inflow current at a transfer position could be measured by applying an arbitrary secondary transfer voltage. The measurement was performed under the following conditions.
Toner: AccurioPress C14000 toner manufactured by Konica Minolta, Inc.
Images: Two images of 10 mm×10 mm squares were arranged side by side equally in the lateral direction at the center of the recording material in the sheet feeding direction (longitudinal direction). The squares were a square filled with a single color black at a density of 50% (50% black) and a square filled with magenta at a density of 100% and cyan at a density of 100% (100% blue).
Preparation: While changing the secondary transfer voltage by 250 V, a white image was printed on the entire surface, and the inflow current flowing to the transfer position was measured. The secondary transfer voltage to be applied for obtaining a desired inflow current (secondary transfer current) was grasped.
   Evaluation method: While a target inflow current value was changed from 10 μA to 250 μA in increments of 20 μA, images were printed on both sides in a state in which each current value (each secondary transfer voltage in a work place) was set. On the second surface, 50% black and 100% blue were visually observed, and rank evaluation was performed according to the following criteria.
Rank 5: no pinholes
Rank 4: with a small number of pinholes observed in 50% black
Rank 3: with a small number of pinholes observed in 100% blue
Rank 2: with pinholes significantly observed in 50% black
Rank 1: with pinholes significantly observed in 100% blue
Pinhole evaluation: Rank 3 or higher was considered to be acceptable.
Evaluation of a pinhole OK current value range: evaluated as “C” for less than 50 μA, evaluated as “B” for 50 μA or more and less than 70 μA, and evaluated as “A” for 70 μA or more. The pinhole OK current value range is a range of a current value in a case where no pinhole occurs. The current value range in a case where no pinhole occurs is a range to an upper limit current value in a case where no pinhole occurs and in a case where an inflow current value in a case where no pinhole occurs is set as a reference current value and the inflow current is increased (by 10 μA) from the reference current value.

### (Method for Measuring Surface Roughness)

The surface roughness of each secondary transfer body was measured under the following conditions in an environment of 20° C. and 50%.
Apparatus: Surfcom manufactured by Tokyo Seimitsu Co., Ltd
JIS94 standard roughness measurement
Measurement length of 5 mm
Speed of 0.15 mm/sec
Measurement range of ±64 μm
λc of 2.5 m
Measurement method: An average value of measured values at a total of four points, i.e., two points in the width direction of an image on each secondary transfer body and two points in the rotation direction of each secondary transfer body, was calculated.

### (Method for Measuring Contact Angle)

The water contact angle of the surface of each secondary transfer body was measured under the following conditions.
Device: a contact angle meter manufactured by Kyowa Interface Science Co., Ltd
Liquid type: pure water, a 2θ method
Measurement method: An average value of measured values at 20 points in the width direction of an image on each secondary transfer body was calculated, and an approximate range of measured values at three points in the rotation direction for two belts was calculated.

### (Evaluation of Separability of Recording Material)

In an environment at a temperature of 10° C. and a humidity of 15%, the peeling property of the recording material was evaluated using AccurioPress C14000 manufactured by Konica Minolta, Inc. under the following conditions.
Recording material: AURORA L manufactured by Nippon Paper Industries, Ltd, with A3 size, 64 g/m², and grain short
Image type: white on entire surfaces of both sides
Evaluation method: While changing the target inflow current value from 120 μA to 240 μA in increments of 20 μA, five sheets were printed on both sides in a state in which the current value was set to each current value (each secondary transfer voltage in the work place). When a sheet jam occurred even once, it was determined to be unacceptable.

### Results

Table 1 indicates the main configurations and the evaluation results of the above-described Examples and Comparative Examples.

TABLE 1

| | Primary | Secondary | Volume | Surface | SiO2 + organic | | Static | | |
|---|---|---|---|---|---|---|---|---|---|
| | transfer | transfer | resistance | roughness | component | Contact | eliminating | | |
| | belt | belt | (Log) | Rz | coated layer | angle | means | Pinhole | Separability |
| Example 1 | PI | PI | 9.7 | 0.4 μm | Not present | 75-80 | Present | B | |
| Example 2 | PI | PI | 12.8 | 0.4 μm | Not present | 75-80 | Present | A | Acceptable in case |
| | | | | | | | | | of 200 μA or less |
| Example 3 | PI | PI | 13.99 | 0.4 μm | Not present | 75-80 | Present | A | Acceptable in case |
| | | | | | | | | | of 120 μA or less |
| Example 4 | PI | PI | 12.8 | 0.4 μm | Not present | 75-80 | Not present | A | Not acceptable even |
| | | | | | | | | | in case of 120 μA |
| Example 5 | PI | PI | 12.8 | 2 μm | Not present | 75-80 | Present | A | Acceptable in case |
| | | | | | | | | | of 240 μA or less |
| Example 6 | PI | PI | 12.8 | 1.2 μm | Present | 90-95 | Present | A | Acceptable in case |
| | | | | | | | | | of 240 μA or less |
| Comparative | PI | PVDF | 9.65 | 0.6 μm | Not present | 90-95 | Present | A | Acceptable in case |
| Example 1 | | | | | | | | | of 240 μA or less |
| Comparative | PI | PI | 7.17 | 0.4 μm | Not present | 75-80 | Present | C | |
| Example 2 | | | | | | | | | |

As indicated in Table 1, in Example 1, a fluorine-free electron conductive material (polyimide) is used as the secondary transfer body, and the volume resistivity of the secondary transfer body is 1×10^{9.7} Ω·cm. By setting the volume resistivity to 1×10^{9.7} Ω·cm, the generation of the low-resistance portion to the secondary transfer bias was suppressed. Therefore, the formation of a conductive path and the generation of a discharge current were suppressed, and the occurrence of pinholes was suppressed.

In Example 2, by making the volume resistivity of the secondary transfer body higher than that in Example 1, the occurrence of pinholes was suppressed. The separability of the recording material is acceptable in a case where the current value is 200 μA or less, which is a practical level.

In Example 3, the volume resistivity of the secondary transfer body was made higher than that in Example 2, so that the occurrence of pinholes was suppressed. The separability of the recording material is acceptable in a case where the current value is 120 μA or less. In Example 3, as compared with Example 2, the volume resistivity increased and the surface resistance also increased. For this reason, it is considered that the electrostatic attraction of the recording material to the secondary transfer body at the separation section is increased.

In Example 4, similarly to Example 2, the occurrence of pinholes was suppressed. However, the separability of the recording material decreased. In Example 4, since the driving of the separation assisting section is stopped, residual charges on the back surface of the leading end of the recording material are not removed at the separation section. Therefore, it is considered that the recording material was attracted to the secondary transfer body by static electricity.

In Example 5, similarly to Example 2, the occurrence of pinholes was suppressed. In Example 5, the roughness Rz of the secondary transfer body was 2 μm, and the pure water contact angle was 75° to 80°. That is, it is considered that the mechanical adhesion force to the recording material was reduced because the surface of the belt was rough in Example 5.

In Example 6, similarly to Example 2, the occurrence of pinholes was suppressed. In Example 6, the roughness Rz of the secondary transfer body was 1.2 μm, and the pure water contact angle was 90° to 95°. In Example 6, it is considered that since the releasability was high due to the coated layer and the surface roughness was rough, the mechanical adhesion force of the recording material S to the secondary transfer body decreased at the separation section.

In Comparative Example 1, both the suppression of the occurrence of pinholes and the separability of the recording material are good, but the secondary transfer body is an ion conductive material (PVDF).

In Comparative Example 2, the secondary transfer body is made of a fluorine-free electron conductive material (polyimide) similarly to Example 1. However, since the volume resistivity was low, the formation of the conductive path and the generation of the discharge current were not suppressed, and the occurrence of pinholes increased.

### [Relationship Between Volume Resistivity and Pinholes]

Next, based on the measurement results of Examples 1 to 6 and Comparative Examples 1 to 2, the relationship between the volume resistivity of the secondary transfer body and the occurrence of pinholes will be described.

FIG. 15 is a graph of pinhole rank with respect to secondary transfer voltage. FIG. 15 illustrates the results obtained when the secondary transfer body made of an electron conductive material (polyimide) (Example 1) and the secondary transfer body of an ion conductive material (PVDF) (Comparative Example 1) were used. FIG. 15 illustrates changes in pinhole rank depending on the temperature and humidity environment for each secondary transfer body. When the secondary transfer voltage is increased, a potential difference (secondary transfer bias) is increased with respect to a local low-resistance portion in a gap at a transfer position p1, and electric discharge occurs, so that the pinhole rank is lowered. Further, in a low-temperature and low-humidity environment, the resistance becomes high, so that the secondary transfer voltage for obtaining a necessary inflow current becomes high.

In FIG. 15, a broken line indicates the stability of the pinhole rank with respect to environmental variations.

In the low-temperature and low-humidity environment, the electron conductive material (polyimide) and the ion conductive material (PVDF) are both at rank 5 in a case where the secondary transfer voltage is a voltage indicated by the broken line. On the other hand, when the same voltage is applied in a general environment (23° C. and 50%), the ion conductive material (PVDF) is at rank 1. In contrast, the electron conductive material (polyimide) is at rank 2. As described above, with respect to the stability of the pinhole rank against a change in the temperature and humidity environment, the electron conductive material (polyimide) having a small change in resistance is excellent.

As a result, the secondary transfer body is made of a high-hardness resin, and combined with a high-load cleaning system, and thus both high quality (suppression of unwiped portions) and high durability can be achieved. Therefore, an image forming apparatus using a secondary transfer body which does not use fluorine and does not have a highly releasable surface can be formed.

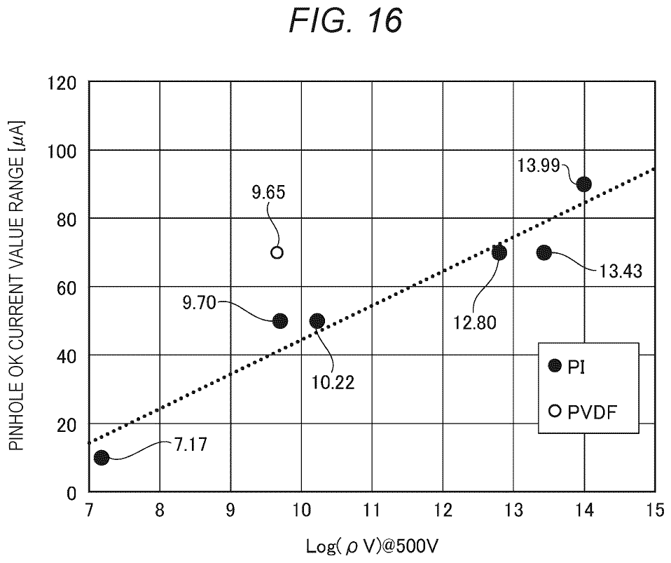

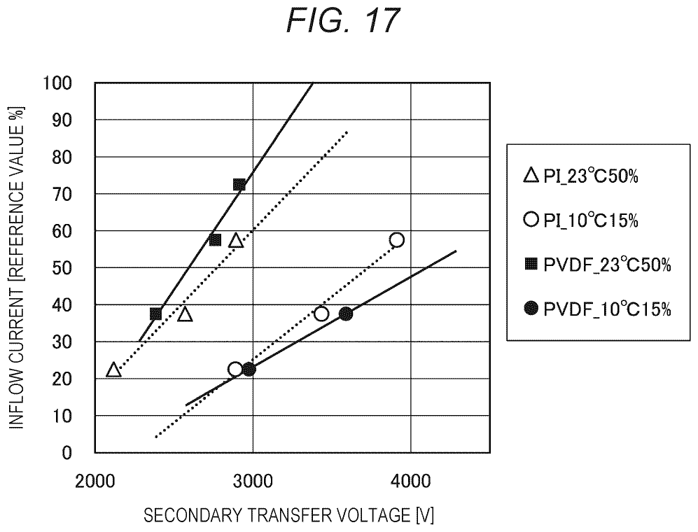

FIG. 16 is a graph illustrating the relationship between the volume resistivity of each of the secondary transfer bodies of Examples and Comparative Examples and the pinhole OK current value range.

The graph illustrated in FIG. 16 illustrates the relationship between the volume resistivity and pinholes in a case where the secondary transfer bodies (Examples 1 to 6 and Comparative Example 2) of the electron conductive material (polyimide) and the secondary transfer body (Comparative Example 1) of the ion conductive material (PVDF) are used. The horizontal axis represents the volume resistivity of each belt. The volume resistivity is represented with a multiplier (1×10^{X} Ω·cm). The vertical axis represents a current value range “μA” in a case where no pinhole occurs.

As illustrated in FIG. 16, when the volume resistivity of the electron conductive material (polyimide) is increased, the pinhole OK current value range increases. From this, the occurrence of pinholes is suppressed by increasing the volume resistivity of the secondary transfer body. Further, even in a case where the secondary transfer bodies have the same volume resistivity (about 10^{9.7} Ω·cm), the electron conductive material (polyimide) has a narrower pinhole OK current value range than that of the ion conductive substance (PVDF). From this result, the occurrence of pinholes does not depend only on the volume resistivity. Since it is difficult to uniformly disperse the electron conductive agent in the resin, the uniformity of resistance is inferior to that of PVDF. Therefore, it is estimated that a conductive path is formed in the low-resistance portion, and a pinhole is likely to occur due to discharge.

The secondary transfer body having a volume resistivity of 10^{7.17} Ω·cm and made of the electron conductive material (polyimide) has a narrow pinhole OK current value range (10 μA) with pinpoint accuracy. In an actual apparatus to which various errors are added, it is substantially impossible to control the inflow current value within such a narrow range and prevent the occurrence of a pinhole.

The belts of which volume resistivity of the electron conductive material (polyimide) is 10^{9.7} Ω·cm have a pinhole OK current value range of 50 μA, and it is expected that the current value can be controlled in an actual apparatus. Therefore, the volume resistivity of the secondary transfer body is preferably 10^{9.7} Ω·cm or more. Furthermore, the volume resistivity of the secondary transfer body is more preferably 1×10^{12.8} Ω·cm or more because a pinhole OK current value range of 70 μA, which is equivalent to that of an ion conductive material (PVDF), can be ensured.

### [Current-Voltage Characteristics]

Next, based on the evaluation results of the secondary transfer body (polyimide) of Example 1 and the secondary transfer body (PVDF) of Comparative Example 1 described above, a description will be provided on the value of the inflow current into the opposing roller r21 with respect to the secondary transfer voltage. FIG. 17 illustrates the relationship between the value of the inflow current of the secondary transfer body to the opposing roller and the secondary transfer voltage in each of Example 1 and Comparative Example 1. FIG. 17 illustrates changes in the inflow current due to the temperature and humidity environment for each secondary transfer body. The higher the resistance of the secondary transfer body is for the same secondary transfer voltage, the smaller the inflow current is. In general, it is considered that the resistance of the ion conductive type tends to fluctuate more easily than the electron conductive type due to the temperature and humidity environment. From FIG. 17, when changes in the current value (that is, resistance) due to changes in the temperature and humidity environment are compared, it is found that the change in the current value is smaller and the change in the resistance is smaller in the secondary transfer body (polyimide) of Example 1 than in the secondary transfer body (PVDF) of Comparative Example 1.

### [Transfer Efficiency]

Next, the relationship between transfer efficiency and pinholes will be described. The relationship between transfer efficiency and pinholes was evaluated using the secondary transfer body of Example 3 described above and a secondary transfer body of Example 7 described below.

### Example 7

In Example 7, the secondary transfer body produced in the same manner as in Example 3 was installed in an image forming apparatus AccurioPress C6100 manufactured by Konica Minolta, Inc. Then, image formation was performed at a processing speed of 460 mm/sec that was lower than that in Example 3.

### (Transfer Efficiency)

The transfer efficiency was measured under the following conditions.
Apparatus: A fluorescent spectrodensitometer FD7 manufactured by Konica Minolta, Inc.
Image: a pinhole evaluation image
Evaluation method: The transfer efficiency was estimated from the measurement of the density of a 100% blue portion. In a case where the intended image density and color tone of the image forming apparatus are obtained, the transfer efficiency is 100%. Then, the transfer efficiency under each condition was estimated according to a decrease in the density from the density in a case where the transfer efficiency is 100% and the color difference from that in a case where the transfer efficiency is 100%. The transfer efficiency of 90% or more was evaluated as o and the transfer efficiency of less than 90% was evaluated as x. Incidentally, in practice, on the side where the inflow current value is high, a decrease in the image density and a color difference occur together with the occurrence of a white spot, but the evaluation of the white spot is omitted because it is determined by the image rank.

### [Evaluation Results]

The evaluation results of pinholes and transfer efficiency in Examples 3 and 7 are indicated in Table 2.

TABLE 2

| Inflow current μA | | 30 | 50 | 70 | 90 | 110 | 130 | 150 | 170 | 190 | 210 | 230 | 250 | 270 | 290 |
|---|---|---|---|---|---|---|---|---|---|---|---|---|---|---|---|
| Example | Pinhole | — | — | — | ∘ | ∘ | ∘ | ∘ | ∘ | ∘ | ∘ | ∘ | x | x | x |
| 3 | Transfer | — | — | — | x | x | ∘ | — | — | — | — | — | — | — | — |
| | efficiency | | | | | | | | | | | | | | |
| Example | Pinhole | ∘ | ∘ | ∘ | ∘ | ∘ | ∘ | ∘ | x | x | x | x | x | | |
| 7 | Transfer | x | x | ∘ | — | — | — | — | — | — | — | — | — | | |
| | efficiency | | | | | | | | | | | | | | |

As indicated in Table 2, images were evaluated starting with an image formed with a low inflow current (secondary transfer current), and the transfer efficiency was determined to be “∘” in a case where the inflow current was equal to or higher than the inflow current value determined to be “∘”

In Example 3, pinholes were determined as “∘” in a case where the inflow current was 90 μA to 230 μA, and the transfer rate was determined as “∘” in a case where the inflow current was 130 μA or more. An appropriate image was obtained in a case where the inflow current was 130 μA to 230 μA.

In Example 7, pinholes were evaluated as “∘” in a case where the inflow current was 30 μA to 150 μA, and the transfer efficiency was evaluated as “∘” in a case where the inflow current was 70 μA or more. An appropriate image was obtained in a case where the inflow current was 70 μA to 150 μA.

In a case where the inflow current was in the range of 70 μA to 230 μA surrounded by a broken line frame in Table 2, even when the processing speed was changed, an appropriate image was obtained. Further, in a case where the inflow current was 130 μA to 150 μA surrounded by a solid line frame in Table 2, an appropriate image was obtained even when the processing speed was changed. Therefore, the inflow current value is preferably 70 μA to 230 μA, particularly preferably 130 μA to 150 μA.

It should be noted that the present invention is not limited to the configuration described in the above embodiment, and various modifications and changes can be made without departing from the configuration according to the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image bearing member that carries a toner image;
a secondary transfer body that sandwiches a recording material together with the image bearing member; and
a potential difference forming section that forms a potential difference between a potential of the image bearing member and a potential of the secondary transfer body, wherein
the image bearing member and the secondary transfer body have a belt shape and contain a resin having electronic conductivity, and
the secondary transfer body has a volume resistivity of 1×10^{9.7} Ω·cm or more.

2. The image forming apparatus according to claim 1, wherein
the image bearing member, the toner image, the recording material, and the secondary transfer body are sandwiched between an opposing member in contact with the image bearing member and a secondary transfer member in contact with the secondary transfer body, and
the potential difference forming section forms a potential difference between the opposing member and the secondary transfer member by a direct current.

3. The image forming apparatus according to claim 2, wherein the potential difference forming section supplies a current of 70 μA or more and 230 μA or less to at least one of the opposing member and the secondary transfer member.

4. The image forming apparatus according to claim 1, further comprising a separation assisting section at a position where the recording material is separated from the secondary transfer body, wherein
the separation assisting section includes an electrode that forms a potential difference between the secondary transfer body and the recording material.

5. The image forming apparatus according to claim 1, wherein the secondary transfer body has a surface that comes into contact with the recording material and has a maximum height of 1.2 μm or more.

6. The image forming apparatus according to claim 2, wherein the secondary transfer member has a straight shape.

7. The image forming apparatus according to claim 6, wherein a surface of the secondary transfer member is a rigid body.

8. The image forming apparatus according to claim 7, wherein the surface of the secondary transfer member is made of metal.

9. The image forming apparatus according to claim 1, further comprising a cleaning section that removes a foreign substance adhering to a surface of the secondary transfer body, wherein
the cleaning section includes a blade that contacts the surface of the secondary transfer body.

10. The image forming apparatus according to claim 1, further comprising a lubricant applying section that supplies a lubricant to a surface of the secondary transfer body.

11. The image forming apparatus according to claim 1, wherein a surface of the secondary transfer body contains polyimide.

12. The image forming apparatus according to claim 1, wherein the secondary transfer body includes a base material containing polyimide, and a surface layer formed on the base material.

13. The image forming apparatus according to claim 12, wherein the surface layer of the secondary transfer body contains SiO₂.

14. The image forming apparatus according to claim 1, wherein a pure water contact angle of a surface of the secondary transfer body is 90° or more.

15. The image forming apparatus according to claim 1, wherein the image bearing member has a thickness of 50 μm or more and less than 70 μm.

16. The image forming apparatus according to claim 1, further comprising a controller that controls driving of the secondary transfer body, wherein
the controller drives a surface of the secondary transfer body at a movement speed of 310 mm/sec or more.
